(19) United States
(12) Patent Application Publication
(10) Pub. No.: US 2011/0318052 A1
(43) Pub. Date: Dec. 29, 2011

(54) PROCESS CARTRIDGE

(75) Inventor: Jun Shirayanagi, Ushiku-shi (JP)

(73) Assignee: CANON KABUSHIKI KAISHA, Tokyo (JP)

(21) Appl. No.: 13/167,151

(22) Filed: Jun. 23, 2011

(30) Foreign Application Priority Data
Jun. 28, 2010 (JP) 2010-146198

(51) Int. Cl. G03G 21/18

(52) U.S. Cl. 399/111

(57) ABSTRACT

A process cartridge detachably mountable to a main assembly of an image forming apparatus includes an image bearing member; a developer carrying member for developing an electrostatic image on the image bearing member; a first gear provided on the developer carrying member and a second gear driving-connected to the first gear; and a supporting portion for rotatably supporting the second gear. The supporting member is mounted on a frame of the process cartridge through a vibration damping member having a vibration transmission performance lower than that of at least the supporting portion.

### FIELD OF THE INVENTION AND RELATED ART

The present invention relates to a process cartridge including a developing device in which a developer carrying member and a developer stirring member are interrelated with a gear mechanism provided at a longitudinal end portion. Specifically, the present invention relates to a structure for damping vibration of an image bearing member due to vibration generated by the gear mechanism.

An image forming apparatus in which an electrostatic image formed on the image bearing member is developed into a toner image and the toner image is transferred onto a recording material directly or via an intermediary transfer member and then is heat-fixed has been widely used.

In the developing device, the developer carrying member (developing sleeve or developing roller) and a plurality of developer stirring members (feeding screw and stirring blade) and disposed side by said with respect to a longitudinal direction. These members are connected at an outside of a developing container by using a gear mechanism.

Further, in a process cartridge in which the developing device is incorporated, in some cases, a driving force to be transmitted to the image, bearing member (photosensitive drum), a charging member (charging roller), a cleaning member (for brush) and the like is distributed by using the same gear mechanism.

With respect to the developing device or process cartridge in which the developer carrying member and the developer stirring (feeding) member are integrally interrelated with each other by the gear mechanism, vibration generated by the gear mechanism with an operation of the developing device is problematic. Vibration of various frequency components generated by variation in engagement of the gear mechanism produces resonance to vibrate the image bearing member, so that pitch non-uniformity of image scanning lines occur. This is problematic and therefore a structure for dampering the vibration is incorporated in the gear mechanism.

Further, when the vibration of the developing device is transmitted to a casing structure of the image forming apparatus, the vibration is transmitted to a laser beam exposure device through the casing structure, so that the pitch non-uniformity of the scanning lines which is amplified to several tens of times through an optical system. For this reason, countermeasures such that a vibration damping material is interposed at a mounting position of the developing device and that rigidity of the casing structure is enhanced have been employed.

In a process cartridge described in Japanese Laid-Open Patent Application (JP-A) Hei 06-051576, the vibration of the image bearing member is damped by providing a gear mechanism for rotating the image bearing member independently of a gear mechanism for interrelating the developer carrying member and the developer feeding member.

In a process cartridge described in JP-A Hei 10-171331, the vibration of the image bearing member is damped by independently providing gear mechanisms for transmitting a driving force to a charging device, a developing device and a cleaning device.

JP-A 2008-129090 discloses that a side plate for supporting a driving unit is formed in a low-rigidity portion in order to suppress transmission of vibration of the driving unit, to a main assembly side, for driving the image bearing member and the developer carrying member.

However, in the constitutions of JP-A Hei 06-051576 and JP-A Hei 10-171331, the vibration generated from the gear mechanism itself is transmitted to a frame as it is, so that the pitch non-uniformity of the image scanning lines occurs. Further, in the constitution of the process cartridge in JP-A 2008-129090, the vibration of the driving unit in which a driving source and driving gear train provided at a main assembly side of the image forming apparatus are integrally assembled can be less transmitted to the main assembly. However, in the case of a cartridge detachably mountable to the main assembly, the vibration of the cartridge itself into which the driving force is inputted from the main assembly-side driving source cannot be suppressed.

In recent years, with an increase in process speed of the image forming apparatus, there is a tendency to increase a frequency of the vibration of the gear mechanism generated in the developing device to increase an amplitude of the vibration. On the other hand, as a result of downsizing of the image forming apparatus, it is difficult to enhance rigidity of the casing structure and vibration transmission among components, such as the exposure device, incorporated in the casing structure is liable to occur. Further, in the case where the laser beam exposure device is employed, when the exposure device is downsized, a length of optical path becomes long, so that a proportion of the influence of the vibration of the exposure device on the image becomes high.

Therefore, when the pitch non-uniformity of the image scanning lines formed on the recording material is measured and statistically processed, it was found that the scanning line pitch non-uniformity which coincides with a vibration period of the gear mechanism of the developing device largely affects an image quality.

### SUMMARY OF THE INVENTION

A principal object of the present invention is to provide a process cartridge, in which an image bearing member and a developing device are integrally assembled, capable of suppressing vibration of the image bearing member due to vibration generated from a drive transmission mechanism provided in the process cartridge.

According to an aspect of the present invention, there is provided a process cartridge detachably mountable to a main assembly of an image forming apparatus, comprising:

an image bearing member;

a developer carrying member for developing an electrostatic image on the image bearing member;

a first gear provided on the developer carrying member and a second gear driving-connected to the first gear; and

a supporting portion for rotatably supporting the second gear,

wherein the supporting member is mounted on a frame of the process cartridge through a vibration damping member having a vibration transmission performance lower than that of at least the supporting portion.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a developing device at a cross section perpendicular to a longitudinal direction of the developing device.

FIG. 3 is an illustration of a planar structure of the developing device.

FIG. 4 is a block diagram of a driving system of a process cartridge.

Parts (a) and (b) of FIG. 5 are illustrations of a side member in Embodiment 1.

FIG. 6 is an illustration of an assembling structure of the side member in Embodiment 1.

FIG. 7 is an illustration of a gear structure.

FIG. 8 is an illustration of a mounted structure of a front cover.

FIG. 9 is an illustration of a planar structure of a developing device in Embodiment 2.

Parts (a) and (b) of FIG. 10 are illustrations of a side member in Embodiment 2.

FIG. 11 is an illustration of an assembling structure of the side member in Embodiment 2.

FIG. 12 is an illustration of a planar arrangement of a gear structure.

### DESCRIPTION OF THE PREFERRED EMBODIMENTS

Embodiments of the present invention will be described with reference to the drawings. The present invention is also applicable to other embodiments in which a part or all of constituents are replaced with their alternative constituents so long as a supporting member for supporting a gear mechanism is mounted on a developing container through a rubber material.

Therefore, the present invention can be carried out in various image forming apparatuses irrespective of types including a full-color/monochromatic type, a charging system, a laser beam exposure/LED array exposure type, a transfer system, a tandem/one-drum type, and an intermediary transfer/recording material conveyance/direct transfer type.

In this embodiment, only a principal portion relating to toner image formation and transfer will be described but the present invention can be carried out in image forming apparatuses, for various purposes, such as printers, printing machines, copying machines, facsimile machines and multi-function, machines by adding necessary equipment, device and casing structure.

Incidentally, general matters of image forming apparatuses, developing devices and process cartridges described in JP-A Hei 06-051576 and JP-A Hei 10-171331 will be omitted from illustration and redundant description.

### <Image Forming Apparatus>

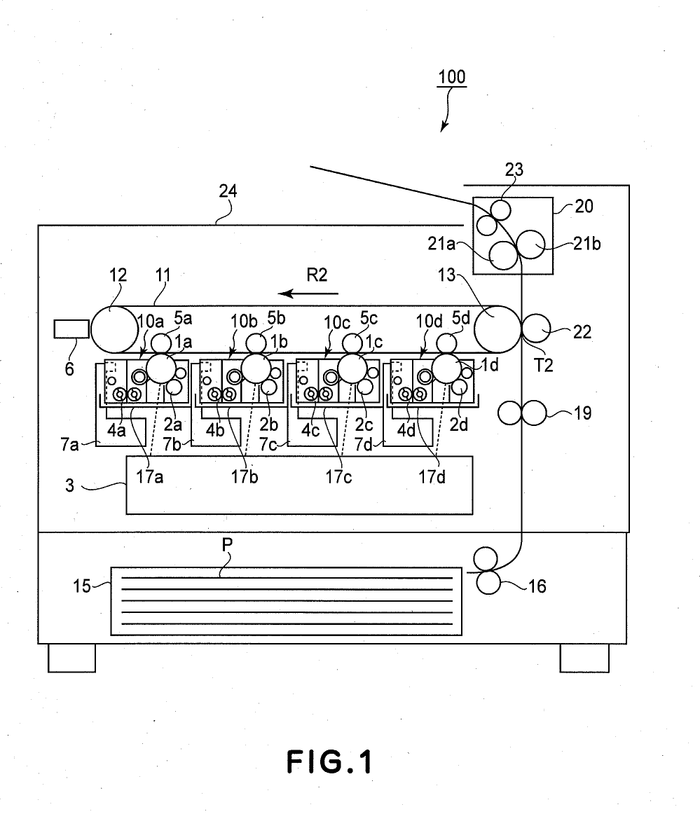

FIG. 1 is an illustration of a structure of an image forming apparatus. As shown in FIG. 1, an image forming apparatus 100 is a tandem type full-color printer of an intermediary transfer type in which process cartridges 10a for yellow, 10b for magenta, 10c for cyan and 10d for black are juxtaposed along an intermediary transfer belt 11.

In the process cartridge 10a, a yellow toner image is formed on a photosensitive drum 1a and then is transferred onto the intermediary transfer belt 11. In the process cartridge 10b, a magenta toner image is formed on a photosensitive drum 1b and then is transferred onto the intermediary transfer belt 11. In the process cartridges 10c and 10d; a cyan toner image and a black toner image are formed on photosensitive drums 1c and 1d, respectively, and then are transferred onto the intermediary transfer belt 11.

The four color toner images transferred onto the intermediary transfer belt 11 are conveyed to a secondary transfer portion T2, where the toner images are secondary-transferred onto a recording material P. The recording material P picked out from a recording material cassette 15 is separated one by one by a separation roller 16 and is fed to a registration roller 19. The registration roller 19 sends the recording material P to the secondary transfer portion T2 while timing the recording material P to the toner images on the intermediary transfer belt 11. The recording material P onto which the toner images are transferred from the intermediary transfer belt 11 are heated and pressed by a fixing device 20, so that the toner images are fixed on the recording material P. Therefore, the recording material P is discharged to an outside 24 of the image forming apparatus 100.

The process cartridges 10a, 10b, 10c and 10d are individually detachably mountable to an apparatus main assembly of the image forming apparatus 100 by being extracted from and inserted into the apparatus main assembly from a front side of the image forming apparatus 100. The process cartridges 10a, 10b, 10c and 10d have the substantially same constitution except that the colors of toners used in developing devices 4a, 4b, 4c and 4d are different from each other. In the following description, the process cartridge 10a will be explained. With respect to other process cartridges 10b, 10c and 10d, respectively constituent elements should be construed by reading the suffix a of corresponding constituent elements of the process cartridge 10a as b, c and d, respectively.

The process cartridge 10a includes the photosensitive drum 1a, a charging roller 2a and the developing device 4a. Around the photosensitive drum 1a, in the order that an image forming process is performed, the charging roller 2a, an exposure device 3, the developing device 4a, a primary transfer roller 5, and deck brush and fur brush which are used for effecting simultaneous development and cleaning are disposed. The process cartridge 10a is prepared by integrally assembling the photosensitive drum 1a, the charging roller 2a, the developing device 4a and the cleaning device into a cartridge.

The photosensitive drum 1a is prepared by applying an organic photoconductor (OPC) photosensitive member onto an outer peripheral surface of an aluminum cylinder of 30 mm in diameter. The photosensitive drum 1a is rotatably supported at longitudinal end portions. To one end portion of the photosensitive drum 1a, a driving force is transmitted, so that the photosensitive drum 1a is rotated at a predetermined process speed. The charging roller 2a is rotated by the photosensitive drum 1a in contact to the surface of the photosensitive drum 1a. By applying to the charging roller 2a an oscillating voltage of DC voltage biased with an AC voltage, the surface of the photosensitive drum 1a is electrically charged to a uniform dark-portion potential VD.

The exposure device 3 scans the surface of the photosensitive drum 1a, through a rotation mirror, with a laser beam binary-modulated depending on an to image signal to lower a potential of the photosensitive drum 1a at an exposed portion to a light-portion portion VL, thus writing (forming) an electrostatic image. The developing device 4a deposits the toner on the exposed portion of the photosensitive drum 1a, thus developing the electrostatic image into a toner image on the photosensitive drum 1a. A toner supplying device 7a supplies a developer consumed with image formation to the developing device 4a.

The intermediary transfer belt 11 are extended and supported by a driving roller 13, which also functions as an opposite roller, and a tension roller 12 and is rotated in an arrow R2 direction at a predetermined process speed. The intermediary transfer belt 11 is constituted by a film-like member. The primary transfer roller 5a presses an inner surface of the intermediary transfer belt 11 toward the photosensitive drum 1a to form a primary transfer position between the intermediary transfer belt 11 and the photosensitive drum 1a. A secondary transfer roller 22 contacts the intermediary transfer belt 11 surfaced from the inside by the opposite roller 13 to form the secondary transfer portion T2.

By applying a DC voltage of a positive polarity to the primary transfer roller 5a, a negatively charged toner image carried on the photosensitive drum 1a is primary-transferred onto the intermediary transfer belt 11. By applying a DC voltage of the positive polarity to the secondary transfer roller 22, the toner images carried on the intermediary transfer belt 11 are secondary-transferred onto the recording material P passing through the secondary transfer portion T2 on the intermediary transfer belt 11.

A charging member provided downstream of the primary transfer portion negatively charges transfer residual toner, which is positively charged and passes through the primary transfer portion, while dispersing the transfer residual toner on the surface of the intermediary transfer belt 11. The negatively charged toner is used again in the developing device 4a, so that the simultaneous development and cleaning is effected.

In the fixing device 20, a pressing roller 21b is press-contacted to a heating roller 21a which is internally heated to form a heating nip therebetween. In the heating nip, the recording material P is nip-conveyed and is subjected to application of heat and pressure, so that the toner image is heat-fixed on the surface of the recording material P.

### <Developing Device>

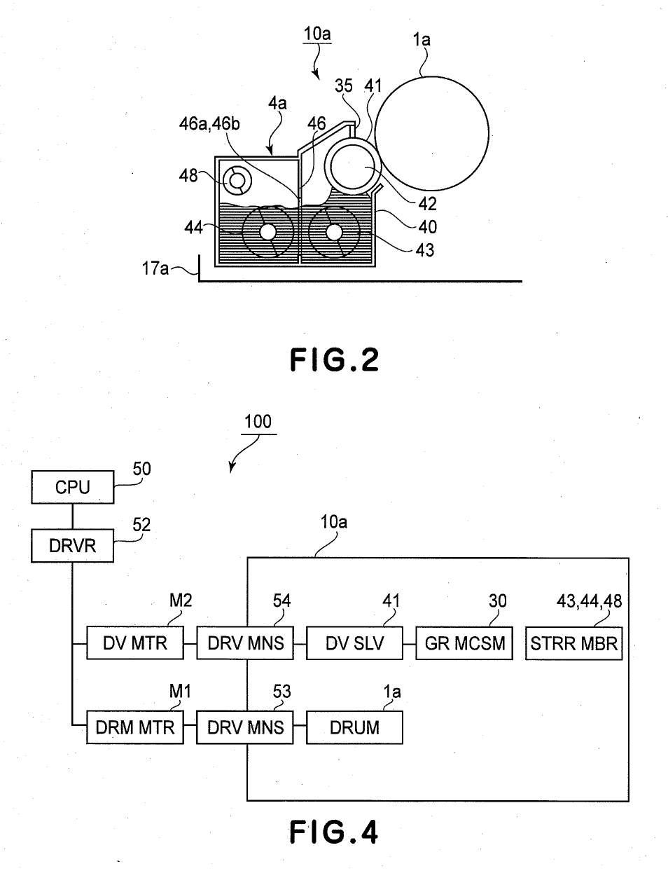

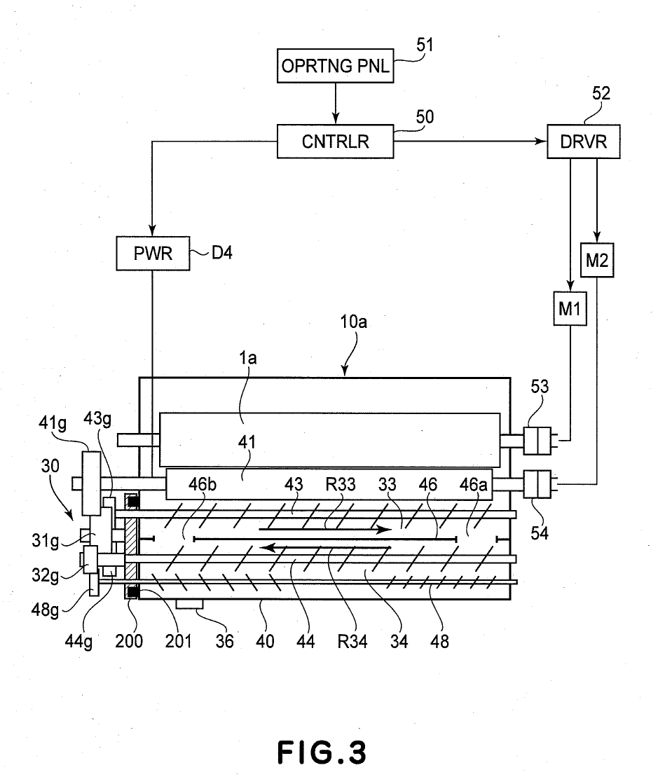

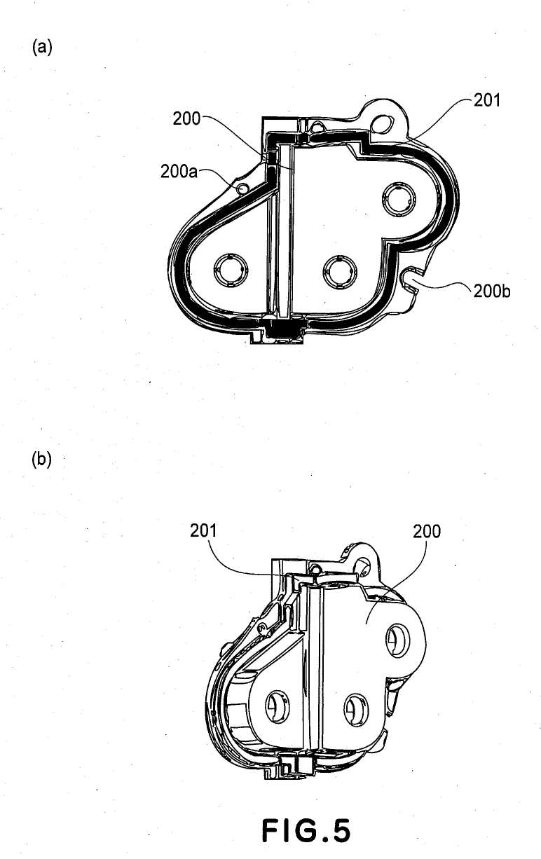

FIG. 2 is an illustration of a structure of the developing device at a cross section perpendicular to a longitudinal direction. FIG. 3 is an illustration of a planar structure of the developing device. FIG. 4 is a block diagram of a driving system of the process cartridge.

As shown in FIG. 2, the process cartridge 10a includes a developing sleeve 41, which is an example of the developer carrying member, on which the developer containing the toner and a carrier is carried, and develops the electrostatic image on the photosensitive drum 1a with the developer.

In the developing device 4a, a two-component developer in which the toner (magnetic) and the carrier (non-magnetic) are mixed is stirred to triboelectrically charge the toner and the carrier to the negative polarity and the positive polarity, respectively.

The developing sleeve 41 rotates about a fixed magnet 42 at the center thereof and a magnetic force of the fixed magnet 42 attracts the carrier at the surface of the developing sleeve 41, so that the two-component developer is coated on the surface of the developing sleeve 41. The two-component developer coated on the surface of the developing sleeve 41 is regulated in its layer thickness by a layer thickness-regulating blade 35 and then is conveyed to an opposing portion where the developing sleeve 41 opposes the photosensitive drum 1a, so that a magnetic brush is formed so as to rub the surface of the photosensitive drum 1a.

An oscillating voltage in the form of a negative DC voltage biased with an AC voltage is applied from a voltage source (D4: FIG. 4) to the developing sleeve 41, so that the toner is transferred onto the electrostatic image on the photosensitive drum 1a which is positive relative to the developing sleeve 41 and thus the electrostatic image is developed.

The toner is transferred onto the photosensitive drum 1a with the development of the electrostatic image, while the carrier is moved back into a developing chamber 33 and is continuously circulated in the developing container 40. For this reason, an amount of the toner in the two-component developer is decreased with cumulative image formation and therefore the toner supplying device 7a supplies the developer (toner) to the developing device 4a during image formation.

As shown in FIG. 3, the developing sleeve 41 which is an example of the developer carrying member develops the electrostatic image on the photosensitive drum 1a which is an example of the image bearing member. The developing container 40 accommodates the developer to be carried on the developing sleeve 41. A developing screw 43 and a stirring screw 44 which are examples of the developer stirring member are disposed in parallel to the developing sleeve 41 in the developing container 40.

The developing container 40 is partitioned into a developing chamber 33 and a stirring chamber 34 by a longitudinal partition wall. The stirring chamber 34 extends in the longitudinal direction in parallel to the developing chamber 33 and communicates with the developing chamber 33 through openings 46a and 46b formed at longitudinal end portions of the partition wall 46. The developing screw 43 supplies the developer in the developing chamber 33 to the developing sleeve 41 while feeding the developer in an arrow 33 direction. The stirring screw 44 feeds the developer in the stirring chamber 34 in an arrow 34 direction opposite to the arrow 33 direction for the developing screw 43, thus circulating the developer between the stirring chamber 34 and the developing chamber 33.

In the neighborhood of the opening 46b through which the developer is transferred from the stirring chamber 34 to the developing chamber 33, a toner content (concentration) sensor 36 for detecting toner content of the developer conveyed in the stirring chamber 34 is provided.

As shown in FIG. 4, a program executed by a central processing unit (CPU) of a controller 50 is received by a driver 52. The driver 52 drives a developing device motor M2 as a develop source for the developing sleeve 41 and a drum motor M1 as a develop source for the photosensitive drum 1a. The develop force of the developing device motor M2 is transmitted to the developing sleeve 41 by a coupling 54 and is further transmitted to the developing screw 43 and the stirring screw 44 via a gear mechanism 30 in the process cartridge 10a. The develop force of the drum motor M1 is transmitted to the photosensitive drum 1a by a coupling 53.

Incidentally, as a chronic trouble of the image forming apparatus 100, image defect such that a pitch-like stripe pattern and uneven image occurs with respect to a sub-scan direction (conveyance direction) has been conventionally known. This image defect is hereinafter referred to as pitch non-uniformity image.

The image defect referred to as the pitch non-uniformity image is generated by transmission of rotation non-uniformity or vibration of the gear mechanism 30 for the process cartridge 10a or the image forming apparatus 100 to the photosensitive drum la and then by writing (formation) of the image in a vibration state of the photosensitive drum 1a. Therefore, in the conventional image forming apparatus, the gear mechanism for driving the image bearing member and the gear mechanism for the charging roller or the cleaning device are provided independently of each other, so that the vibration of the gear mechanism for the image bearing member is prevented from transmitting to the other gear mechanism. Thus, a degree of the occurrence of the pitch non-uniformity image is reduced and a high image quality is obtained.

For example, in JP-A Hei 06-051576, separately from the gear mechanism for the developing device, the gear mechanism for the photosensitive drum is provided, so that the vibration of the gear mechanism generated by a fluctuation in load of the developing device is prevented from being transmitted to the photosensitive drum.

Further, in JP-A Hei 10-171331, in the process cartridge, the gear mechanisms for the charging roller, the developing device and the cleaning device are provided independently of each other, so that a degree of transmission of the vibration to the photosensitive drum is reduced.

However, the image defect (pitch non-uniformity image) is also generated by vibration of the exposure device 3 caused due to transmission of the vibration generated in the gear mechanism to a main assembly frame of the image forming apparatus 100 via the process cartridge 10a.

With respect to this problem, the methods proposed in JP-A Hei 06-051576 and JP-A Hei 10-171331 are not so effective. This is because an effect of suppressing the vibration of the process cartridge 10a itself is poor. Thus, such a problem that the vibration generation in each of the gear mechanisms is transmitted through the main assembly frame of the image forming apparatus to reach the exposure device has occurred.

In the following embodiments, the rotation non-uniformity and vibration in the gear mechanism for the developing device are confined in a supporting member by interposing a vibration damping member of a rubber material between a side wall and the developing container. In the process cartridge (developing device), the side wall at a side where the gear mechanism for the developing container is disposed is separately provided and is engaged with the developing container by a positioning means such as a boss causing less vibration transmission between the side wall and the developing container. As a result, the rotation non-uniformity and vibration in the gear mechanism for the developing device is prevented from being transmitted to the developing container of the developing device 4a and to the main assembly frame of the image forming apparatus 100.

### Embodiment 1

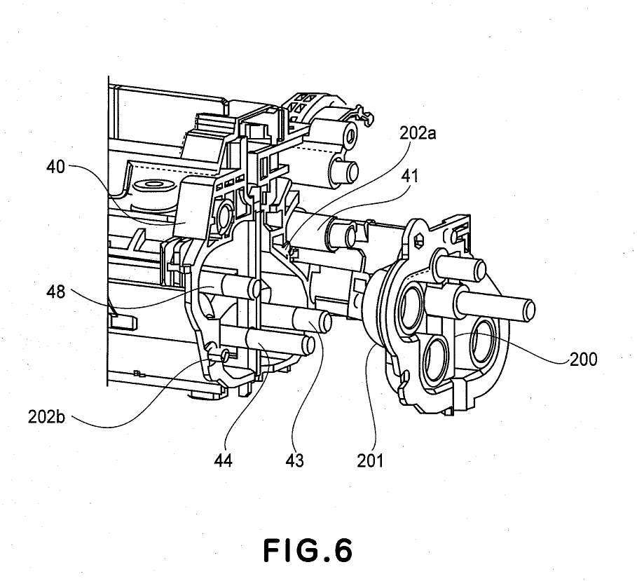

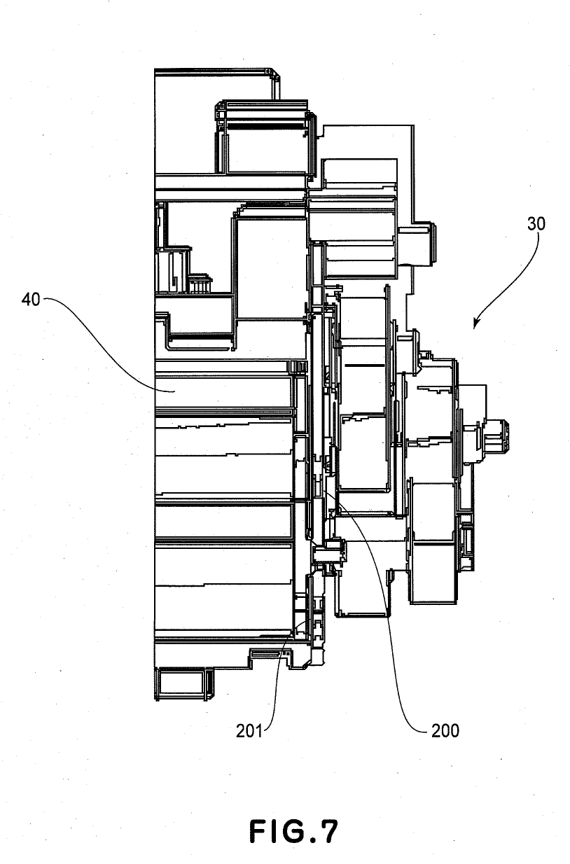

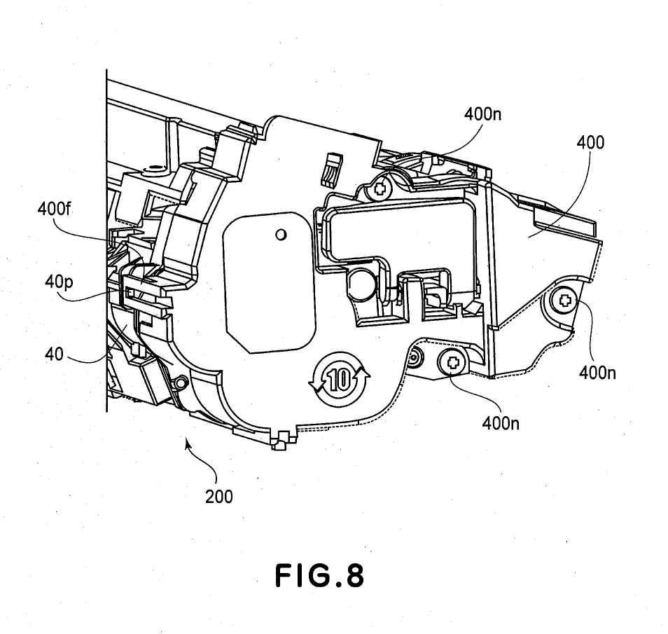

Parts (a) and (b) of FIG. 5 are illustrations of a side member in this embodiment. FIG. 6 is an illustration of an assembling structure of the side member in this embodiment. FIG. 7 is an illustration of a gear structure. FIG. 8 is an illustration of a mounted structure of a front cover.

As shown in FIG. 5 with reference to FIG. 3, the gear mechanism 30 as a develop connection means in this embodiment interrelate the rotates of the developing sleeve 41 and the developer stirring members 43 and 44 at the outside of the developing container 40 with respect to the longitudinal direction. A side member 200 which is an example of the supporting member is supported by the developing container 40 via an elastic member 201 which is an example of a vibration damping member having a vibration transmission performance lower than that of the developing container 40. The side member 200 integrally supports the developing sleeve 41, the developing screw 43, the stirring screw 44 and the gear mechanism 30.

As shown in FIG. 6, the side member 200 also functions as a longitudinal end portion wall surface of the developing container 40, and the elastic member 201 also functions as a sealing member of a rubber material for sealing a gap between the developing container 40 and the side member 200 so as to prevent leakage of the developer from the gap.

As shown in FIG. 7, the gear mechanism 30 is disposed only at longitudinal one end side of the developing container 40. Further, as shown in FIG. 3, the developing container 40 is prepared by being integrally molded with an end portion wall surface, at the other end side thereof, for supporting the developing sleeve 41, the developing screw 43, the stirring screw 44 and a developer feeding screw 48.

As shown in FIG. 3, the first coupling 53 separably connects a rotation shaft of a first develop source M1 at the image forming apparatus main assembly side to a rotation shaft of the photosensitive drum 1a penetrated through the end portion wall surface at the other end side. The second coupling 54 separably connects a rotation shaft of a second develop source M2 at the image forming apparatus main assembly side to a rotation shaft of the developing sleeve 41 penetrated through the end portion wall surface at the other end side.

As shown in (a) of FIG. 5, the elastic member 201 is prepared by ejection molding performed so as to bury an elastic material of elastomer in a part of a resin material for the side member 200. The elastic member 201 is fixed to the side member 200, so that there is no need to worry about dropping as in the case of an O ring even when the elastic member 201 is handled during an assembling process. Thus, by interposing the elastic member 201 between the developing container 4 and the side member 200, it is possible to prevent leakage of the developer through the gap between the developing container 4 and the side member 200.

As shown in (a) of FIG. 5, the side member 200 is provided, as a positioning structure relative to the end portion of the developing container 40, with an engaging hole 200a and an engaging U-shaped groove 200b. On the other hand, as shown in FIG. 6, the developing container 40 is provided, as a positioning structure relative to the side member 201, with bosses 202a and 202b.

As shown in FIG. 6, the developing sleeve 41, the developing screw 43, the stirring screw 44 and the developer feeding screw 48 are mounted to the developing container 40 in advance. Then, by inserting the side member 200 provided with bearing members (not shown) for the respective rotatable members, relative positions of the developing sleeve 41, the developing screw 43, the stirring screw 44 and the developer feeding screw 48 are determined.

As shown in (b) of FIG. 5, the side member 200 is molded so that its central portion projects toward an inner space of the developing container 40. For this reason, when the side member 200 is mounted to the developing container 40, the side member 200 is guided by the central portion, so that the side member 200 is quickly positioned relative to the end portion of the developing container 40.

The side member 200 is assembled by engaging the positioning boss 202a of the developing container 40 with the engaging hole 200a of the side member 200 and by engaging the boss 202b with the engaging U-shaped groove 200b.

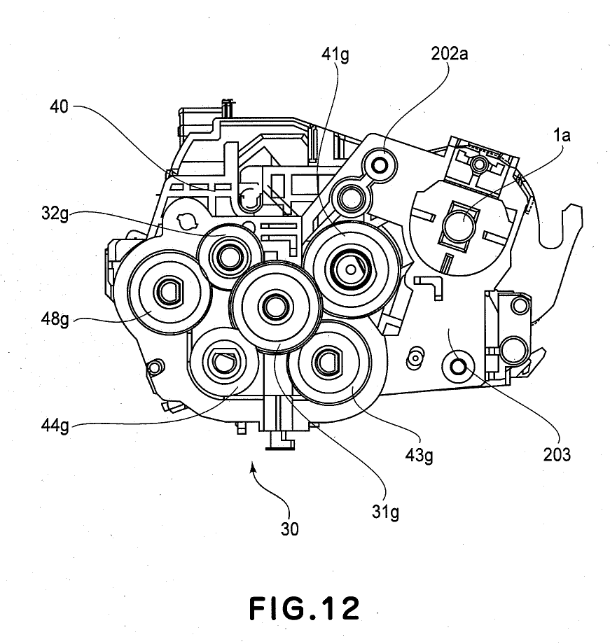

As shown in FIG. 7, in a state in which the side member 200 is mounted to the developing container 40, the gear mechanism 30 is assembled with the side member 200. A planar arrangement of respective gears will be described later in Embodiment 2 with reference to FIG. 12.

As shown in FIG. 8, a front cover 400 which is an example of a cover member is disposed outside the side member 200 so as to cover the gear mechanism 30. The front cover 400 also functions as a mounting member, for the side member 200, for urging the side member 200 in a direction in which the front cover 400 is locked by the developing container 40 and the elastic member 201 is compressed.

At a locking portion 40p of the process cartridge 10a, a hook 400f of the front cover 400 is locked, and the front cover 400 is fixed at three portions 400n with screws at the photosensitive drum side. The side member 200 and the elastic member 201 are sandwiched between the developing container 40 and the front cover 400 which is fixed in the above-described manner, thus being fixed while sealing the gap therebetween.

In the process cartridges 10a, 10b, 10c and 10d in this embodiment, the side member 200 provided with the gear mechanism 30 and the developing container 40 for supporting the side member 200 are prepared as separate parts. Further, by interposing the vibration damping member of the rubber material between the side member 200 and the developing container 40, the vibration generated in the gear mechanism is prevented from being transmitted to the photosensitive drum 1a and the developing container 40.

The side member 200 which holds the gear mechanism 30 is in a state in which the elastic member 201 is sandwiched between itself and the developing container 40, so that the vibration generation in the gear mechanism 30 is absorbed by the elastic member 201 and thus is little transmitted to the developing container 40. In this embodiment, the rotation non-uniformity and vibration of gears generated in the gear mechanism 30 are absorbed by the flexible vibration damping member to be prevented from being s transmitted to the developing container 40, so that the vibration is prevented from reaching the exposure device 3.

As a result, it becomes possible to prevent the pitch non-uniformity image caused due to the vibration of the gear mechanism 30 for the process cartridges 10a, 10b, 10c and 10d or the developing devices 4a, 4b, 4c and 4d.

Further, in this embodiment, a developer feeding and stirring member 300 is, as shown in FIG. 6, mountable from one side direction of the process cartridge 10a, so that an assembling property can be improved. The developing container 40 and the side member 200 which constitutes a cap thereof are provided as separate members, so that the parts such as the developing screw 43 and the stirring screw 44 can be assembled linearly from the mounting side of the side member 200. For this reason, in the assembling by a manual operation, the assembling property and a checking property are improved. Further, from the mounting side of the side member 200, all the parts can be assembled and fixed, so that it becomes possible to easily adapt the parts to an automatic assembling device.

Incidentally, the elastic member 201 may be formed of a material, such as a sealing material of a rubber type, a silicone-type or sponge-type, which has Young's modulus lower than that for the developing container 40. The elastic member 201 may also be mounted at the developing container 40 side.

Further, the positioning structure between the side member 200 and the developing container 40 is not limited to the boss engagement structure but may also be another positioning structure which is not the boss engagement structure.

Further, in this embodiment, the gear driving-side side wall of the developing container 40 is constituted by the side member 200 but the other side wall (opposite from the gear driving-side side wall) may be provided as a separate member. Thus, it is also possible to employ a constitution in which the longitudinal end members of the developing container are provided as separate members.

Further, as shown in FIG. 3, outside the developing container 40 having the longitudinal end portions where the respective rotatable members are sealed, the side member 200 provided with the gear mechanism 30 and the bearing members for the respective rotatable members may also be disposed. In this embodiment, the elastic member 201 is not required to seal the gap between the developing container 40 and the side member 200 so as to prevent the leakage of the developer and therefore there is no need to form the elastic member 201 in a closed-curve shape. The side member 200 may only be required to be supported via the elastic member 201 at a plurality of positions by the outer wall surface of the developing container 40.

### Embodiment 2

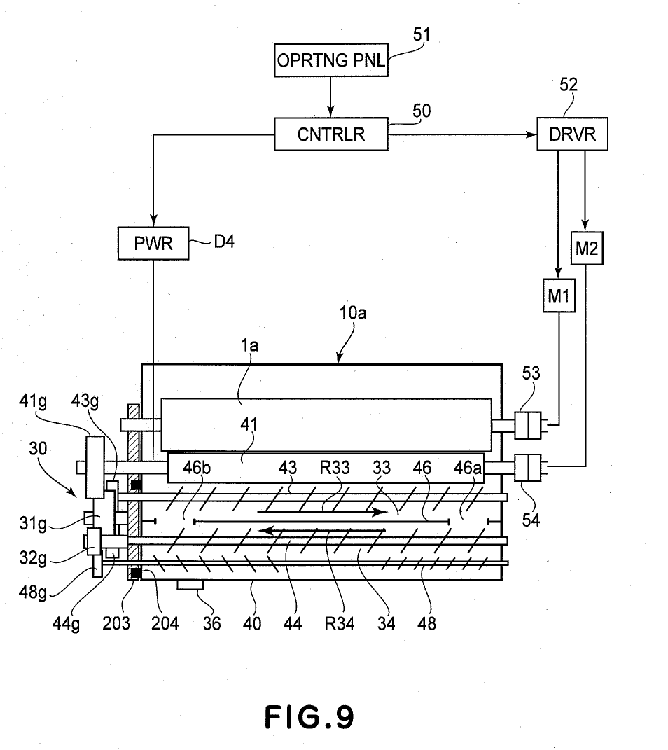

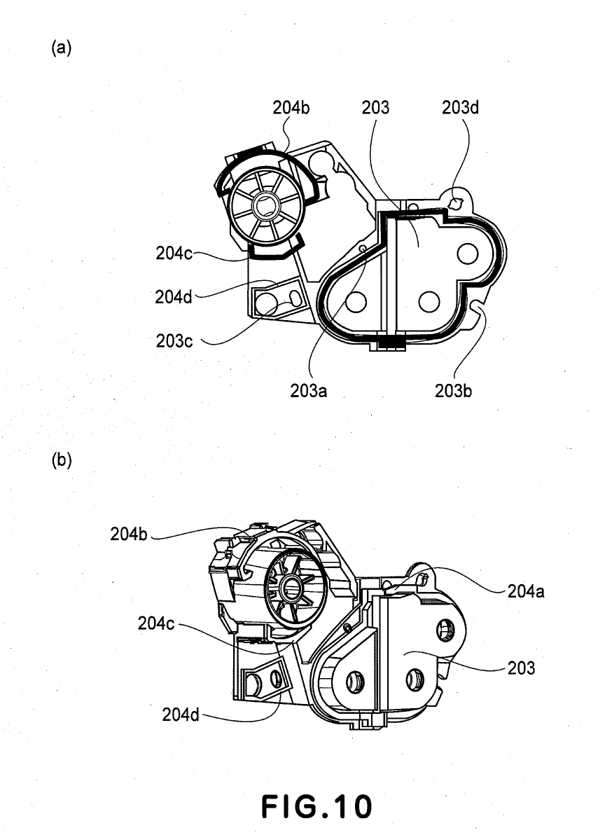

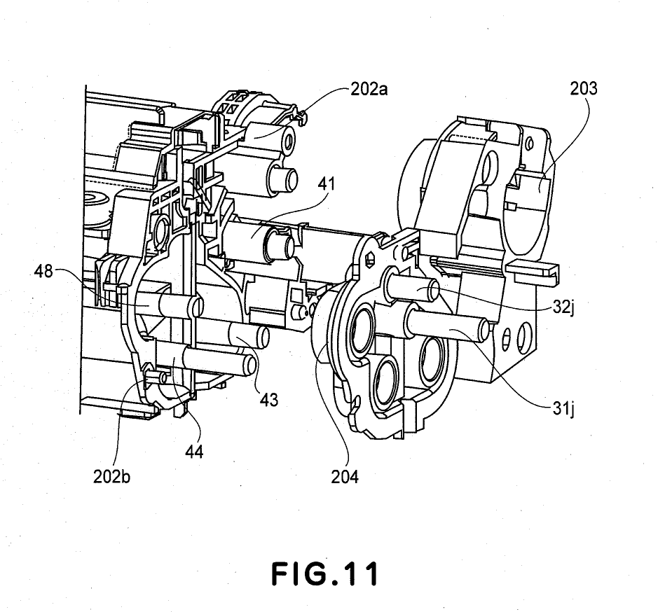

FIG. 9 is an illustration of a planar structure of a developing device in this embodiment. Parts (a) and (b) of FIG. 10 are illustrations of a side member in this embodiment. FIG. 11 is an illustration of an assembling structure of the side member in this embodiment. FIG. 12 is an illustration of a planar arrangement of a gear structure.

As shown in FIG. 9, in this embodiment, compared with Embodiment 1, the side member is formed in a large size, so that the developing sleeve 41 and the photosensitive drum 1a are also integrally supported by the side member. With respect to the developing container 40 and the respective rotatable members, the same constitutions as those in Embodiment 1. Therefore, in FIGS. 9 to 12, constituent elements common to Embodiment 1 are represented by the same reference numerals or symbols and are omitted from redundant description.

As shown in (a) of FIG. 10, an elastic member 204 is mounted to a side member 203. The elastic member 204 is prepared by ejection molding of an elastic material of elastomer on the side member 203, i.e., by so-called hot-melt molding. The elastic member 204 is disposed to form a closed curve so as to surround the periphery of the developing chamber and the stirring chamber of the developing device 40. As a result, it is possible to prevent leakage of the developer through the gap between the developing container 40 and the side member 203. The developer leakage between the developing container 40 and the side member 203 can be prevented by interposing the elastic member 204 between the developing container 40 and the side member 203. Compared with Embodiment 1, added elastic members 204b, 204c and 204d are formed similarly as in the case of the elastic member 204 to alleviate the vibration transmission between the developing container 40 and the side member 203, so that the vibration generated at the side member 203 side is less transmitted to the developing container 40.

The elastic member 203 may be formed of a material, such as a sealing material of a rubber type, a silicone-type or sponge-type, which has Young's modulus lower than that for the developing container 40. The elastic member 201 may also be molded so as to be buried in a part of a resin material for the side member 203 prepared by injection molding of the silicone rubber.

The side member 203 is provided, as positioning boss engagement holes relative to the developing container 40, with an engaging hole 203a, an engaging U-shaped groove 203b and an engaging U-shaped groove 203c. On the other hand, as shown in FIG. 11, the developing container 40 is provided with bosses 202a and 202b. The side member 203 is assembled by engaging the positioning boss 202a of the developing container 40 with the engaging hole 203a of the side member 203 and by engaging the boss 202b with the engaging U-shaped groove 203b.

As shown in FIG. 11, the side member 203 is assembled at the end portion of the developing container 40, so that the developing sleeve 41, the developing screw 43, the stirring screw 44 and the developer feeding screw 48 are positioned. FIG. 11 shows an assembling state of the side member 203 with the developing container 40. After the gear mechanism 30 is assembled as shown in FIG. 7, the side member 203 is sandwiched and fixed between the developing container 40 and a front cover 400 by fixing the front cover 400 to the side member 203 as shown in FIG. 8.

As shown in FIG. 12, after the side member 203 is assembled with the developing container 40, the gear mechanism 30 is assembled with the side member 203. By the side member 203, relative positions among the developing screw 43, the stirring screw 44, the developer feeding screw 48 and the photosensitive drum la are determined. The side member 203 is mounted to the developing container 40 to hold the gear mechanism 30 and the photosensitive drum 1a. A gear 41g is rotated by inputting the driving force from the developing device motor M2 shown in FIG. 9 to the developing sleeve 41. The rotation of the gear 41g is distributed, via an idler gear 31g as a connecting gear, into a gear 43g for the developing screw 43 and a gear 44g for the stirring screw 44. Further, via another idler gear 32g as the connecting roller, the rotational force is transmitted to a gear 48g for the developer feeding screw 48.

With the respect to the idler gears 31g and 32g, as shown in FIG. 11, rotation shafts 31j and 32j are fixed on the side member 203 and therefore engagement vibration of each of the idler gears 31g and 32g directly vibrates the side member 203. In addition to the engagement vibration, a radial force acting on each of the rotation shafts 31j and 32j is fluctuated at a certain period by eccentric rotation of each of the gears 43g, 44g and 48g, so that the side member 203 is vibrated. A load fluctuation of each of the developing screw 43 and the stirring screw 44 also causes the vibration of the side member 203 through an unshown bearing member.

When a coupling (complex) vibration of these factors is transmitted to the developing container 40 as it is, the vibration is transmitted from the developing container 40 to the main assembly casing of the image forming apparatus 100, so that the exposure device 3 is vibrated. When the exposure device 3 is vibrated, even when the light source of the laser beam causes a slight angular fluctuation, a beam spot position largely fluctuates on the photosensitive drum la, so that the pitch non-uniformity of the scanning lines is conspicuous on the outputted image.

In this embodiment, the side member 203 which holds the gear mechanism 30 and the photosensitive drum 1a is in a state in which the elastic member 204 is sandwiched between itself and the developing container 40, so that the gear vibration generation in the gear mechanism 30 is absorbed by the elastic member 204 and thus is little transmitted to the developing container 40. As a result, it becomes possible to prevent the pitch non-uniformity image caused due to the process cartridges 10a, 10b, 10c and 10d or the gear mechanism 30.

Further, also in this embodiment, the respective rotatable members assembled with the developing container 40 are mountable from one side direction of the developing container 40, so that an assembling property can be improved.

Further, also in Embodiment 2, it is also possible to employ a constitution in which the side member 203 is provided at each of the longitudinal end portions of the developing container 40 and is provided as a separate member from the developing container 40. The elastic member 204 may also be mounted at the developing container 40 side.

In the process cartridge of the present invention, the vibration damping member is disposed between the supporting member and the developing container and therefore the vibration generated in the gear mechanism for the developing device is confined in the supporting member and thus is not transmitted to the developing container. As a result, the vibration transmitted from the developing device to the casing structure of the image forming apparatus is suppressed without relying on the casing structure or the mounting structure, so that the scanning line pitch non-uniformity of the outputted image can be reduced.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 146198/2010 filed Jun. 28, 2010, which is hereby incorporated by reference.

What is claimed is:

1. A process cartridge detachably mountable to a main assembly of an image forming apparatus, comprising:
an image bearing member;
a developer carrying member for developing an electrostatic image on said image bearing member;
a first gear provided on said developer carrying member and a second gear driving-connected to said first gear; and
a supporting portion for rotatably supporting said second gear,
wherein said supporting member is mounted on a frame of said process cartridge through a vibration damping member having a vibration transmission performance lower than that of at least said supporting portion.

2. A cartridge according to claim 1, wherein said second gear rotates around a fixed shaft fixed at said supporting portion.

3. A cartridge according to claim 1, wherein said supporting portion is mounted on an image bearing member supporting portion, for rotatably supporting said image bearing member, through at least the vibration damping member.

4. A cartridge, further comprising an accommodating portion for accommodating a developer to be supplied to said developer carrying member and a stirring member for stirring the developer in said accommodating portion,
wherein said second gear transmits a driving force from said developer carrying member to said stirring member.

5. A cartridge according to claim 4, wherein said supporting portion includes a bearing portion for supporting rotation shafts of said developer carrying member and said stirring member.

6. A cartridge according to claim 1, further comprising an urging member for urging said supporting portion in a direction in which said vibration damping member is compressed.

7. A cartridge according to claim 6, wherein said urging member also functions as a cover portion for covering said second gear.

8. A cartridge according to claim 1, wherein said supporting portion forms a part of a wall surface of an accommodating portion for accommodating a developer to be supplied to said developer carrying member, and wherein said vibration damping member also functions as a sealing member of a rubber material for sealing a gap between said accommodating portion and said supporting portion so as to prevent leakage of the developer from the gap.

9. A cartridge, further comprising a first coupling for separably connecting a rotation shaft of to a first driving source at a main assembly side of the image forming apparatus to a rotation shaft of said image bearing member and a second coupling for separably connecting a rotation shaft of a second driving source at the main assembly side of the image forming apparatus to a rotation shaft of said developer carrying member.
